(19) United States
(12) Patent Application Publication
(10) Pub. No.: US 2008/0122338 A1
(43) Pub. Date: May 29, 2008

(54) Fluorescent lamp with coating inside

(75) Inventor: Zhengyu Song, Shanghai (CN)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SHANGHAI ZHENXIN ELECTRONIC ENGINEERING CO., LTD.

(21) Appl. No.: 11/976,513

(22) Filed: Oct. 25, 2007

(30) Foreign Application Priority Data
Oct. 31, 2006 (CN) CN 200620047317.1

(51) Int. Cl. H01J 1/62

(52) U.S. Cl. 313/486

(57) ABSTRACT

The present invention relates to a fluorescent lamp field, more particularly relates to a type of fluorescent lamp tube with TiO₂ (titanium dioxide) coating. The florescent lamp tube of the present invention can reduce the black sodium amalgam by coating with nanometer titanium dioxide material and selecting effective coating thickness, make the lumen maintenance of fluorescent lamp tube increase 6-8% compared with the ordinary alumina coating, thus greatly enhance the lamp tube's life.

### CROSS-REFERENCE TO RELATED APPLICATION

This application claims priority of Chinese Patent Application No. 200620047317.1, filed Oct. 31, 2006, the disclosure of which is hereby incorporated by reference in its entirety.

### FIELD OF THE INVENTION

The present invention relates to the field of fluorescent lamp tube, more particularly a fluorescent lamp tube with inside coat.

### BACKGROUND OF THE INVENTION

Restricted by the economic and technical development of our country, though the price of glass tube material used to produce compact fluorescent lamp tube is low, the quality is relatively low as well. The low quality mainly displays in two aspects: First, the content of sodium is relatively high and second, the glass tube's blackening by light is serious—as the fluorescent lamp becomes more and more compact, lamp tube's load will enhance further, its operating temperature will also rise constantly, and then the rise of temperature will accelerate thermo-diffusion of the sodium ions in the glass. These sodium ions will proliferate from the interior of the glass to the glass tube's internal surface, compound with the electron there, and form the neutral sodium atom. The sodium atom which has formed in the tube's internal surface will run to the surface of the fluorescent powder pellet through the thermo-diffusion, react with the mercury atom on the surface of the fluorescent powder pellet, and generate black sodium amalgam. The black sodium amalgam generated on the surface of the fluorescent powder pellet, will on one hand absorb the stimulation ultraviolet ray with 253.7 nm length wave radiating to the surface of the fluorescent powder pellet, and thus prevent the fluorescent powder pellet from receiving full stimulation; on the other hand, the black sodium amalgam on the surface of the fluorescent powder pellet will reduce lumen output of the lamp. From the above analysis we can see that the sodium element in the glass is one of the primary factors which cause the drop of lamp lumen maintenance rate, but the effect of aluminum oxide inside coat which is universally used at present is certainly not very satisfactory.

### SUMMARY OF THE INVENTION

This invention applies the nanometer titanium dioxide material as coat. Because the nanometer titanium dioxide has the characteristics such as steady chemical property, no irritating, no sensitive, good compatibility with parent metal, long effect time, comprehensive shield, superfine and uniform particle, fine dispersion and so on. The fluorescent lamp tube's lumen maintenance rate with the nanometer titanium dioxide material coat increases 6-8% compared with the ordinary aluminum oxide coat, and thus the lamp's lifespan is greatly enhanced. The diameter of titanium dioxide material is 10-80 nm. Dilute it to 4-9% with pure water. Mix with a certain quota of dispersing agent and bonding agent to the suspending liquid if needed. Dry it after spreading evenly and spreading repeatedly is also allowed. The coat thickness is 0.8-1.3 um. The following measuring method may be used, which is easy to operate, not too precise but very practical. Choose 5-10 pieces of lamp tube fragment which is measurable in different position of lamp tube, measure each fragment's surface area S, drag down the nanometer titanium dioxide material, measure its weight W and proportion F (Don't take into account the slight change of proportion when mixing some additives), and thus calculate the coat thickness L, namely Ln=Wn/Sn*F (n is 1-10), finally L=L1+L2+ . . . L10/10. Certainly the known advanced optic or electronic or chemistry method also can be applied. (For example, invite the National Non-ferrous Metal Quality Surveillance Test Center to measure).

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 shows the schematic drawing of the entire lamp and place A.

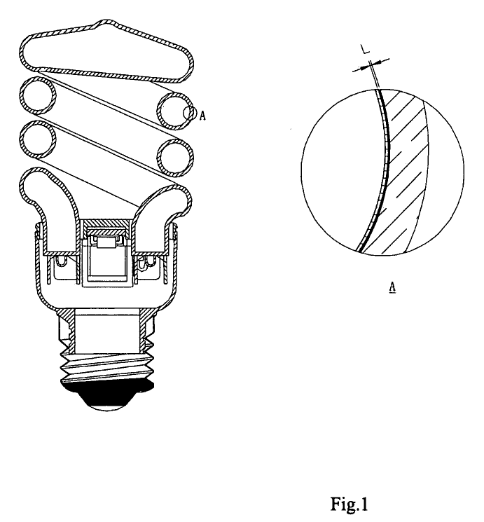

### DETAILED DESCRIPTION

An embodiment of the present invention includes a type of fluorescent lamp tube with inside wall coating, wherein, by coating with water diluted nanometer titanium dioxide material, it forms a membrane structure with the inside wall of lamp tube, which has inside wall glass of lamp tube inside and titanium dioxide membrane outside.

### EXAMPLE 1

Choose 10 nm titanium dioxide, dilute it to 4% with pure water, carry on the coat, bake and solidify it. The lumen maintenance rate of 2000 h lamp will increase 7.8% compared with commonly used aluminum oxide coat. After measured coat thickness is 1.3 um.

### EXAMPLE 2

Choose 50 nm titanium dioxide, dilute it to 5% with pure water, carry on the coat, bake and solidify it, and then spread again. The lumen maintenance rate of 2000 h lamp will increase 7.4% compared with commonly used aluminum oxide coat. After measured coat thickness is 1.0 um.

### EXAMPLE 3

Choose 80 nm titanium dioxide, dilute it to 6% with pure water, carry on the coat and solidify it. The lumen maintenance rate of 2000 h lamp will increase 7% compared with commonly used aluminum oxide coat. After measured coat thickness is 0.8 um.

### EXAMPLE 4

Choose 80 nm titanium dioxide, dilute it to 7% with pure water, carry on the coating and solidify it. The lumen maintenance rate of 2000 h lamp will increase 6.2% compared with commonly used aluminum oxide coat. After measured coat thickness is 0.8 um.

### EXAMPLE 5

Choose 10 nm titanium dioxide, dilute it to 9% with pure water, carry on the coat and solidify it. The lumen maintenance rate of 2000 h lamp will increase 7.6% compared with commonly used aluminum oxide coat. After measured coat thickness is 1.2 um.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed:

1. A type of fluorescent lamp tube with inside wall coating, wherein, by coating with water diluted nanometer titanium dioxide material, it forms membrane structure with the inside wall of lamp tube, which has inside wall glass of lamp tube inside and titanium dioxide membrane outside.

2. The fluorescent lamp tube mentioned in claim 1, characterized in that its coating thickness is 0.8-1.3 um.

3. The fluorescent lamp tube mentioned in claim 1, characterized in that the diameter of the selected nanometer titanium dioxide particle is 10-80 nm.

4. The fluorescent lamp tube mentioned in claim 3, characterized in that the diameter of the nanometer titanium dioxide particle is 10-50 nm.
